(19) United States
(12) Patent Application Publication
(10) Pub. No.: US 2025/0093201 A1
(43) Pub. Date: Mar. 20, 2025

(54) AFFORDABLE HIGH SPECTRAL-RESOLUTION 3D IMAGING LEVERAGING ROBOTIC SCANNING SPECTROSCOPY COMBINED WITH SEMANTIC SLAM

(71) Applicants: Jnaneshwar DAS, Tempe, AZ (US); Saurav KUMAR, Tempe, AZ (US)

(72) Inventors: Jnaneshwar DAS, Tempe, AZ (US); Saurav KUMAR, Tempe, AZ (US)

(73) Assignee: Arizona Board of Regents on Behalf of Arizona State University, Scottsdale, AZ (US)

(21) Appl. No.: 18/886,898

(22) Filed: Sep. 16, 2024

Related U.S. Application Data
(60) Provisional application No. 63/583,236, filed on Sep. 15, 2023.

(51) Int. Cl. G01J 3/02; B25J 19/02; G01J 3/06; G01J 3/10; G01J 3/28; G01N 33/00

(52) U.S. Cl. CPC G01J 3/0202; G01J 3/027; G01J 3/06; G01J 3/10; G01J 3/0208; G01J 2003/069

(57) ABSTRACT

A method of adaptively scanning a selected area that includes selecting an imaging mode, performing a scan of the selected area using the imaging mode, detecting an item of interest, automatically selecting a new imaging mode in response to detecting the item of interest, and performing a scan of the item of interest using the new imaging mode. The imaging mode may determine at least one of a scanning pattern, a scanning speed, and a scanning rate. Spectral data and image data may be gathered and used to detect the item of interest. The method may also include providing a scanning spectrometer system that has a gimbal system configured to provide at least two degrees of freedom to the scanning spectrometer system. The gimbal system may have a spectrometer and a camera each mounted on the gimbal system and configured to gather the spectral data and the image data, respectively.

### RELATED APPLICATIONS

This application claims the benefit of U.S. provisional patent application 63/583,236, filed Sep. 15, 2023, to Das et al., titled “ULTRASCAN: AFFORDABLE HIGH SPECTRAL-RESOLUTION 3D IMAGING LEVERAGING ROBOTIC SCANNING SPECTROSCOPY COMBINED WITH SEMANTIC SLAM,” the entirety of the disclosure of which is hereby incorporated by this reference.

### TECHNICAL FIELD

This document relates to a scanning spectrometer system, and more specifically to a spectrometer system that combines scanning spectrometry, robotics technology, and semantic SLAM.

### BACKGROUND

Spectrometry is a powerful analytical technique used to measure and analyze the properties of light over a specific portion of the electromagnetic spectrum. Spectrometer systems are instrumental in various fields such as environmental monitoring, chemical analysis, medical diagnostics, and materials science. Traditional spectrometers used for scanning typically operate in a pre-defined mode, sweeping across a region of interest (ROI) with fixed parameters. These systems are often limited by their inability to adapt dynamically to varying conditions within the scanned area, leading to inefficiencies in data collection and potentially missing critical information.

In certain applications, it is essential to detect and analyze specific items of interest within a broad area, such as pollutants in environmental monitoring, biomarkers in medical diagnostics, or defects in materials. Conventional spectrometer systems require manual intervention to adjust scanning parameters when an item of interest is detected, resulting in delays and potential loss of critical information. Additionally, manually changing scanning modes increases the complexity of operations and may introduce errors.

### SUMMARY

Aspects of this document relate to a method of adaptively scanning a selected area, the method comprising providing a scanning spectrometer system, the scanning spectrometer system comprising a gimbal system having a flight controller fixedly attached to the gimbal system, the flight controller having a coordinate frame with a yaw axis and a pitch axis, wherein the gimbal system provides a degree of freedom about the yaw axis and a degree of freedom about the pitch axis, a spectrometer mounted on the gimbal system and configured to gather spectral data, the spectrometer having a collimating lens, and a camera mounted on the gimbal system and configured to gather image data, wherein each of the spectrometer and the camera is communicatively coupled with a processing unit onboard the scanning spectrometer system and each of the spectrometer and the camera is configured to communicate the spectral data and the image data, respectively, to the processing unit, selecting an imaging mode for the scanning spectrometer system from a plurality of imaging modes, wherein the imaging mode determines at least one of a scanning pattern, a scanning speed, and a scanning rate, performing a scan of the selected area using the imaging mode to gather the spectral data and the image data, processing the spectral data and the image data with the processing unit, detecting an item of interest using at least one of the spectral data and the image data, automatically selecting a new imaging mode from the plurality of imaging modes in response to detecting the item of interest, performing a scan of the item of interest using the new imaging mode to gather additional spectral data of the item of interest using the spectrometer and additional image data of the item of interest using the camera, and estimating a physicochemical characteristic of the item of interest based on the additional spectral data and the additional image data.

Particular embodiments may comprise one or more of the following features. The physicochemical characteristic of the item of interest may be a plant biotic stress or a plant abiotic stress. The physicochemical characteristic of the item of interest may be a physical property of the item of interest. The image data or the spectral data may comprise a high-resolution point cloud. The method may comprise executing and assembling sinusoidal scan patterns with the gimbal system along the yaw axis and the pitch axis to collect the image data and the spectral data. The scanning spectrometer system may further comprise a xenon lamp mounted on the gimbal system for night-time broad-spectrum spectroscopy.

Aspects of this document relate to a method of adaptively scanning a selected area, the method comprising selecting an imaging mode from a plurality of imaging modes, wherein the imaging mode determines at least one of a scanning pattern, a scanning speed, and a scanning rate, performing a scan of the selected area using the imaging mode, wherein performing the scan comprises gathering spectral data and image data, detecting an item of interest using at least one of the spectral data and the image data, automatically selecting a new imaging mode from the plurality of imaging modes in response to detecting the item of interest, and performing a scan of the item of interest using the new imaging mode to gather additional spectral data and additional image data of the item of interest.

Particular embodiments may comprise one or more of the following features. The method may further comprise providing a scanning spectrometer system to perform the scan of the selected area, the scanning spectrometer system comprising a gimbal system configured to provide at least two degrees of freedom to the scanning spectrometer system, a spectrometer mounted on the gimbal system and configured to gather spectral data, and a camera mounted on the gimbal system and configured to gather image data. The method may further comprise executing and assembling sinusoidal scan patterns with the gimbal system to collect the image data and the spectral data. The method may further comprise estimating a physicochemical characteristic of the item of interest based on the additional spectral data and the additional image data. The physicochemical characteristic of the item of interest may be a plant biotic stress or a plant abiotic stress. The physicochemical characteristic of the item of interest may be a physical property of the item of interest. The image data or the spectral data may comprise a high-resolution point cloud.

Aspects of this document relate to a scanning spectrometer system for adaptively scanning a selected area, the scanning spectrometer system comprising a gimbal system having a coordinate frame with a yaw axis and a pitch axis, wherein the gimbal system provides a degree of freedom about the yaw axis and a degree of freedom about the pitch axis, a spectrometer mounted on the gimbal system and configured to gather spectral data, a camera mounted on the gimbal system and configured to gather image data, and a processing unit communicatively coupled with the spectrometer and the camera, wherein the processing unit is configured to receive the spectral data and the image data from the spectrometer and the camera, respectively, detect an item of interest using at least one of the spectral data and the image data and estimate a physicochemical characteristic of the item of interest based on at least one of the spectral data and the image data, wherein the scanning spectrometer system is configured to select an imaging mode from a plurality of imaging modes, wherein the imaging mode determines at least one of a scanning pattern, a scanning speed, and a scanning rate, perform a scan of the selected area using the imaging mode to gather the spectral data and the image data, automatically select a new imaging mode from the plurality of imaging modes in response to detecting the item of interest, and perform a scan of the item of interest using the new imaging mode to gather additional spectral data of the item of interest using the spectrometer and additional image data of the item of interest using the camera.

Particular embodiments may comprise one or more of the following features. The spectrometer may have a collimating lens. The physicochemical characteristic of the item of interest may be a plant biotic stress or a plant abiotic stress. The physicochemical characteristic of the item of interest may be a physical property of the item of interest. The image data or the spectral data may comprise a high-resolution point cloud. The gimbal system may be configured to execute sinusoidal patterns along the yaw axis and the pitch axis of the coordinate frame. The scanning spectrometer system may further comprise a xenon lamp mounted on the gimbal system for night-time broad-spectrum spectroscopy.

The foregoing and other aspects, features, and advantages will be apparent from the DESCRIPTION and DRAWINGS, and from the CLAIMS if any are included.

### BRIEF DESCRIPTION OF THE DRAWINGS

Implementations will hereinafter be described in conjunction with the appended and/or included DRAWINGS, where like designations denote like elements, and:

FIG. 1 is a perspective view of a scanning spectrometer system according to some embodiments;

FIG. 2 is a front view of a scanning spectrometer system according to some embodiments; and

FIG. 3 is a side view of a scanning spectrometer system according to some embodiments.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The development of a scanning spectrometer system capable of automatically adapting its scanning parameters in real-time upon detecting an item of interest addresses the limitations of conventional scanning spectrometers discussed above. Such a system can enhance efficiency, improve accuracy, and enable more comprehensive data collection by dynamically adjusting the scanning mode to optimize for the detected item's characteristics.

The present disclosure relates to a scanning spectrometer system 100 that incorporates an adaptive scanning method. The scanning spectrometer system 100 is configured to automatically detect items of interest within a scanned area and switch to a different scanning mode optimized for detailed analysis of the detected item. This adaptive capability helps to ensure that the scanning spectrometer system 100 provides high-resolution data where needed, improving overall performance in applications requiring precise and timely spectral analysis.

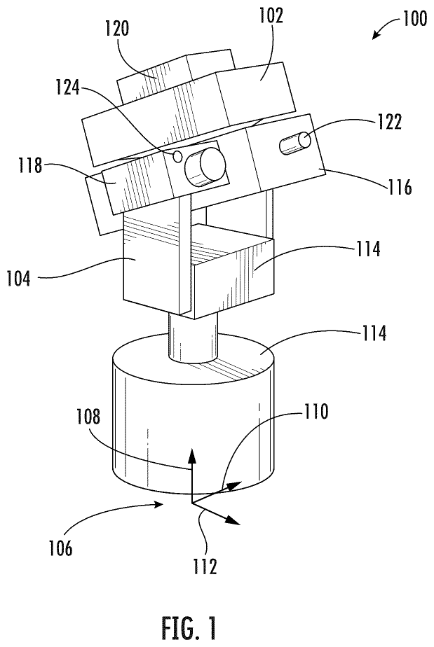

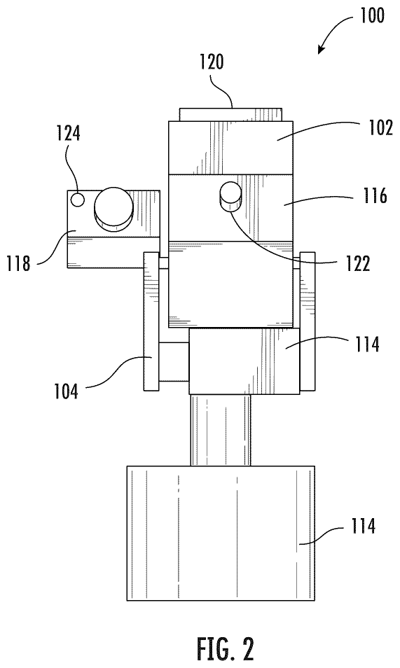

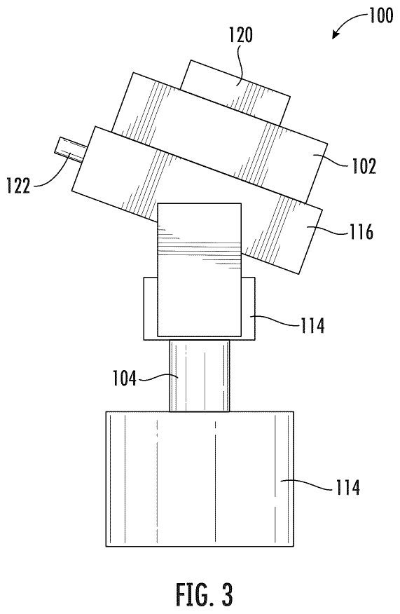

In some embodiments, the scanning spectrometer system 100 is a multi-axis scanning spectrometer system that comprises a flight controller 102 and a gimbal system 104, as shown in FIGS. 1-3. The flight controller 102 may be fixedly attached to the gimbal system 104. In some embodiments, the flight controller 102 comprises a GPS and compass to provide pose and orientation data of the scanning spectrometer system 100. In some embodiments, the flight controller 102 may be an onboard flight controller that runs the PX4 flight stack, such as the Pixhawk flight controller. The flight controller 102 controls the gimbal system 104 to allow the scanning spectrometer system 100 to implement a particular scanning mode or imaging mode. For example, the gimbal system 104 may be used to collect scene data by executing and assembling sinusoidal scan patterns. In some embodiments, the gimbal system 104 is a two-axis gimbal system and therefore has two degrees of freedom. The gimbal system 104 may have a coordinate frame 106 with a yaw axis 108, a pitch axis 110, and a roll axis 112. The gimbal system 104 may provide a degree of freedom about the yaw axis 108 and a degree of freedom about the pitch axis 110. The flight controller 102 may be configured to control the pose/orientation of the gimbal system 104 through a motor 114, which may be a servo, associated with each of the degrees of freedom. Thus, the gimbal system 104, through the flight controller 102, may be configured to execute sinusoidal patterns along the yaw axis 108 and the pitch axis 110. This can be done while the scanning spectrometer system 100 is stationary, with data output being in spherical coordinates, or while moving, with data output being in cylindrical coordinates.

The scanning spectrometer system 100 may also comprise a spectrometer 116 and/or a camera 118 each mounted on the gimbal system 104, as shown in FIGS. 1-3. The spectrometer 116 is configured to gather spectral data and the camera 118 is configured to gather image data. The spectral data and/or the image data may be formatted as point cloud data. Both the spectrometer 116 and the camera 118 may be configured to provide high-definition images and data. In addition, the spectrometer 116 and the camera 118 may be configured to enable GPS-denied operation of the scanning spectrometer system 100 such that the scanning spectrometer system 100 is capable of functioning with or without access to a GPS connection. This may be enabled through semantic SLAM (Simultaneous Localization and Mapping), in which estimated semantics (tree, soil), can be correlated with the spectroscopy point cloud created from data gathered by the spectrometer 116 and the camera 118. Thus, the spectral data and the image data may be used for SLAM and SfM (Structure from Motion). When combined with other modalities, correlated information can be upscaled. To this end, the scanning spectrometer system 100 may comprise a processing unit 120 configured to estimate semantics of the environment surrounding the scanning spectrometer system 100 based on the data gathered by the spectrometer 116 and the camera 118.

The spectrometer 116 may be mounted on the gimbal system 104. In some embodiments, the spectrometer 116 is a UV-VIS-NIR spectrometer such as the OceanOptics Flame spectrometer. The spectrometer 116 may have a collimating lens 122. The collimating lens 122 may be aligned with the roll axis 112 of the coordinate frame 106 when the gimbal system 104 is at its base position. In this way, the degrees of freedom about the yaw axis 108 and the pitch axis 110 allow the gimbal system 104 to point the collimating lens 122 where desired.

The processing unit 120 may be a Robot Operating System (ROS) and may be located onboard the scanning spectrometer system 100. The processing unit 120 may be a computer such as an Intel NUC i5 computer. Other viable computers that would function well as the processing unit 120 will be apparent to one of skill in the art.

The processing unit 120 may be configured to receive and process the spectral data and the image data in real-time. The spectrometer 116 and the camera 118 may be communicatively coupled to the processing unit 120 wirelessly or through a wired connection, such as through USB. Python, OpenCV, and/or AI/ML algorithms may be implemented. Spectral data, image data, scene semantic map, and state-estimates (pose and orientation) may be logged simultaneously and/or in real-time using the processing unit 120. Scene semantics can be used to adaptively scan, producing higher quality information for patches of interest. The goal of this innovation is to enhance the fidelity of environmental monitoring at an affordable price point, while generating data for environmental digital twins, at unprecedented spatio-temporal-spectral resolutions. A primary novelty of the present disclosure is the specific combination of scanning spectrometry, robotics technology, and semantic SLAM. The scanning spectrometer system may be useful in fields such as agriculture, ecology, geology, mining and prospecting, and planetary surface prospecting (e.g., moon). In some embodiments, the spectral data and the image data may be used in connection with a suite of real-time algorithms in the processing unit 120 to provide multi-surface physicochemical properties estimation and/or to detect plant biotic and abiotic stresses at asymptomatic stages.

In some embodiments, the scanning spectrometer system 100 also comprises a xenon lamp 124 mounted on the gimbal system 104. The xenon lamp 124 is configured to provide illumination for the spectrometer 116 and the camera 118 in situations where light levels are low, such as at night. Thus, the xenon lamp 124 may be for night-time broad-spectrum spectroscopy. The xenon lamp 124 because it effectively simulates daylight, thus allowing the same algorithms and databases to be used for scans performed during the day and during the night.

It is considered within the scope of this disclosure to implement the scanning spectrometer system 100 on a ground robot or other ground-based vehicle or on a drone or other air-based vehicle. Thus, the scanning spectrometer system 100 may be mounted on any vehicle, including an aircraft or other flying vehicle, a ground-based vehicle, or even a vehicle traveling below water.

The scanning spectrometer system 100 is configured to adaptively scan and leverage scene semantics. For example, the scanning spectrometer system 100 can leverage output from the scanning spectrometer system 100 to adaptively schedule the scan patterns based on how important the patch of the scene is. For instance, the yaw and pitch motions can be slower around conic sections covering vegetation, and sparser where there is soil or concrete, or vice versa. Similarly, during a scan, the scanning spectrometer system 100 may elect to stop and take pan-tilt scans at strategic locations of a particular object or area of interest. For example, in a lunar application, the system may observe a novel rock and stop to take additional pan-tilt scans at a few locations to get better albedo and pixel beam angles.

A particular method of adaptively scanning using a scanning spectrometer system 100 may be implemented. The method may comprise selecting an imaging mode from a plurality of imaging modes. In some embodiments, the imaging mode determines at least one of a scanning pattern, a scanning speed, and a scanning rate. The method may also comprise performing a scan of a selected area using the imaging mode. Performing the scan comprises gathering the spectral data with the spectrometer 116 and the image data with the camera 118. The method may also comprise processing the spectral data and the image data with the processing unit 120 and using at least one of the spectral data and the image data to detect an item of interest. In some embodiments, the spectral data and the image data are processed onboard the scanning spectrometer system 100. The method may also comprise automatically selecting a new imaging mode from the plurality of imaging modes in response to the detection of the item of interest and performing a scan of the item of interest using the new imaging mode to gather additional spectral data of the item of interest using the spectrometer 116 and additional image data of the item of the interest using the camera 118. The new imaging mode may share some characteristics with the original imaging mode. For example, both imaging modes may be the same scanning pattern, the same scanning speed, or the same scanning rate. Thus, to collect improved data, the new imaging mode may change only one aspect of the scanning, such as by slowing down, changing the pattern by circling the item of interest, or increasing the imaging rate.

The scanning spectrometer system 100 may also be configured to implement real-time and offline data fusion. For example, spectroscopy and camera imagery may be fused using state of the art algorithms such as PyMDE, as well as neural networks such as transformers. Neural Radiance Fields (NeRF) may provide optimal synthesis of the 2048 band spectral point cloud, upscaled to resolution of the RGB camera.

Different imaging modes may be implemented. For example, a 360 spherical scan may be used when the scanning spectrometer system 100 is stationary and a push broom or spherical scan may be used when the scanning spectrometer system 100 is moving. Thus, for example, the plurality of imaging modes may comprise a static mode where the sensor is stationary and scans are carried out in 360 degree panoramic mode with 1 degree increments in yaw axis 108 and the pitch axis 110, and a mobile mode where a robotic vehicle can carry the imager along a path, and scans are assembled using cylindrical coordinates. In both cases, the camera 118 acquires images of the scene concurrently with the spectrometer 116, and data is fused both in real time (sparse) and offline (dense).

Other imaging modes may also be implemented. For example, a third imaging mode may be implemented that is a combination of the two modes discussed above (360 panoramic scans in a static setting and scanning while in motion). This third imaging mode may move around or orbit an object of interest and take scans of the object from multiple perspectives, getting multiple views. This can provide richer data on the surface optical (photometric) and topological properties. Additionally, this may provide more reliable data by taking multiple scans in situations where one scan may be misleading. For example, in a lunar scenario, the sun may interact with regolith or boulders in unusual ways. If the imaging modes discussed above were used and just one scan were taken, the resulting data could be misleading. By orbiting or moving around the object or area of interest multiple times to get multiple scans from various perspectives, more data is gathered that helps to verify that the information gathered by the system is accurate. Other imaging modes may also be implemented

The scanning spectrometer system 100 may be configured to switch between different imaging modes based on the data gathered. For example, the scanning spectrometer system 100 may begin a scan in a first mode where the scanning spectrometer system 100 travels in a straight line or other predetermined pattern but may switch to a new mode based on the data gathered by the systems sensors, such as to take a closer look and to take more detailed scans of an object or area of particular interest. Thus, the scanning spectrometer system 100 may switch to orbiting the object or area of interest. The scanning spectrometer system 100 may also be configured to switch back to the original imaging mode, or to a new imaging mode, once the scanning spectrometer system 100 has completed its investigation of the object or area of interest.

A particular embodiment of the scanning spectrometer system 100 disclosed herein comprises a gimbal system 104 having an onboard flight controller 102 fixedly attached to the gimbal system 104, the flight controller 102 having a coordinate frame 106, wherein the gimbal system 104 is configured to execute sinusoidal patterns along a yaw axis 108 and a pitch axis 110 of the coordinate frame 106, a spectrometer 116 mounted on the gimbal system 104, the spectrometer 116 having a collimating lens 122 configured to gather spectral data of an object, and a RGB camera 118 configured to gather image data of the object, wherein the spectrometer 116 is communicatively coupled with a processing unit 120 and configured to communicate the spectral data and the image data to the processing unit 120 and the processing unit 120 is configured to estimate a physicochemical characteristic of the object based on the spectral data and the image data.

The physicochemical characteristic of the object may be a plant biotic stress or a plant abiotic stress. The physicochemical characteristic of the object may be a physical property of the object. The spectrometer 116 may be a UV-VIS-NIR spectrometer. The image data or the spectral data may comprise a high-resolution point cloud. The spectral data and the image data may be logged in real time. The gimbal system 104 may be configured to collect the image data and the spectral data by executing and assembling sinusoidal scan patterns. The scanning spectrometer system 100 may be configured to adaptively scan. The scanning spectrometer system 100 may further comprise a xenon lamp 124 mounted on the gimbal system 104 for night-time broad-spectrum spectroscopy. The scanning spectrometer system 100 may be useful for night-time fluorescent spectroscopy with a UV laser. Additionally, gimbaling the whole spectrometer can be changed with gimbaling only a spectrally characterized UV-VIS-NIR mirror.

The scanning spectrometer system 100 may be configurable to adapt the system to different situations. For example, prior to using the scanning spectrometer system 100, a user may choose a mapping modality. The mapping modality may be a multiple tripod mounted scanning setup, mounted on a mobility vehicle such as a ground robot or an electrical vehicle, or any other mapping modality. The user may also configure the sensors, including the camera 118 and/or the spectrometer 116. The sensor configuration may be calibrated for intrinsic and extrinsic parameters, such as relative poses. The user may also specify parameters for mapping novelty, such as by providing object classes or criteria for novelty or anomaly for onboard learned models to use for semantic segmentation of the scene.

Many additional implementations are possible. Further implementations are within the CLAIMS.

It will be understood that implementations of the scanning spectrometer system include but are not limited to the specific components disclosed herein, as virtually any components consistent with the intended operation of various scanning spectrometer systems may be utilized. Accordingly, for example, it should be understood that, while the drawings and accompanying text show and describe particular scanning spectrometer system implementations, any such implementation may comprise any shape, size, style, type, model, version, class, grade, measurement, concentration, material, weight, quantity, and/or the like consistent with the intended operation of scanning spectrometer systems.

The concepts disclosed herein are not limited to the specific scanning spectrometer system shown herein. For example, it is specifically contemplated that the components included in particular scanning spectrometer systems may be formed of any of many different types of materials or combinations that can readily be formed into shaped objects and that are consistent with the intended operation of the scanning spectrometer system. For example, the components may be formed of: rubbers (synthetic and/or natural) and/or other like materials; glasses (such as fiberglass), carbon-fiber, aramid-fiber, any combination therefore, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

Furthermore, scanning spectrometer systems may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular scanning spectrometer system implementations, it should be readily apparent that a number of modifications may be made without departing from the spirit thereof and that these implementations may be applied to other implementations disclosed or undisclosed. The presently disclosed scanning spectrometer systems are, therefore, to be considered in all respects as illustrative and not restrictive.

### REFERENCES CITED AND INCORPORATED BY REFERENCE

1. Das, Jnaneshwar, Gareth Cross, Chao Qu, Anurag Makineni, Pratap Tokekar, Yash Mulgaonkar, and Vijay Kumar. “Devices, systems, and methods for automated monitoring enabling precision agriculture.” In 2015 IEEE international conference on automation science and engineering (CASE), pp. 462-469. IEEE, 2015.
2. Rui Wang, Jie Yang, Qiang Shen, Lianru Gao, Zhenwei Shi, and Fengting Yang, “Fusion of Hyperspectral and Multispectral Images Using Spectrometer Data for High-Resolution Image Classification”, Published in: Remote Sensing, 2018
3. Das, J., Evans, W. C., Minnig, M., Bahr, A., Sukhatme, G. S., & Martinoli, A. (2013). Environmental sensing using land-based spectrally-selective cameras and a quadcopter. In Experimental Robotics: The 13th International Symposium on Experimental Robotics (pp. 259-272). Springer International Publishing.
4. “Deep Hyperspectral Image Denoising: A Survey” by Chen et al. (2022).
5. “A Snapshot Hyperspectral Imaging System Using Compressive Sensing and Machine Learning” by Sartor et al. (2021).
6. “Hyperspectral Imaging with Machine Learning for Early Detection of Plant Stress” by Chen et al. (2021).
7. “Super-resolution Hyperspectral Imaging using Deep Learning and Compressed Sensing” by Wang et al. (2020).
8. “High-resolution Hyperspectral Imaging with a Compact Snapshot System using a Single Liquid Crystal Variable Retarder” by Hu et al. (2019).
9. Yan, K., Li, X., He, L., Zhang, X., & Wang, J. (2017). Hyperspectral imaging system based on an unmanned aerial vehicle with scanning mirror. Applied optics, 56(15), 4362-4368.
10. Bodin, M., et al. (2021). PyMDE: A Python Library for Manifold and Dimensionality Reduction Estimation. Journal of Open Source Software, 6(60), 3062. https://doi.org/10.21105/joss.03062
11. Vaswani, A., et al. (2017). Attention Is All You Need. In Advances in Neural Information Processing Systems (NIPS). https://arxiv.org/abs/1706.03762
12. Mildenhall, B., et al. (2020). NeRF: Representing Scenes as Neural Radiance Fields for View Synthesis. In European Conference on Computer Vision (ECCV). https://arxiv.org/abs/2003.08934

We claim:

1. A method of adaptively scanning a selected area, the method comprising:
providing a scanning spectrometer system, the scanning spectrometer system comprising:
a gimbal system having a flight controller fixedly attached to the gimbal system, the flight controller having a coordinate frame with a yaw axis and a pitch axis, wherein the gimbal system provides a degree of freedom about the yaw axis and a degree of freedom about the pitch axis;
a spectrometer mounted on the gimbal system and configured to gather spectral data, the spectrometer having a collimating lens; and
a camera mounted on the gimbal system and configured to gather image data;
wherein each of the spectrometer and the camera is communicatively coupled with a processing unit onboard the scanning spectrometer system and each of the spectrometer and the camera is configured to communicate the spectral data and the image data, respectively, to the processing unit;
selecting an imaging mode for the scanning spectrometer system from a plurality of imaging modes, wherein the imaging mode determines at least one of a scanning pattern, a scanning speed, and a scanning rate;
performing a scan of the selected area using the imaging mode to gather the spectral data and the image data;
processing the spectral data and the image data with the processing unit;
detecting an item of interest using at least one of the spectral data and the image data;
automatically selecting a new imaging mode from the plurality of imaging modes in response to detecting the item of interest;
performing a scan of the item of interest using the new imaging mode to gather additional spectral data of the item of interest using the spectrometer and additional image data of the item of interest using the camera; and
estimating a physicochemical characteristic of the item of interest based on the additional spectral data and the additional image data.

2. The method of claim 1, wherein the physicochemical characteristic of the item of interest is a plant biotic stress or a plant abiotic stress.

3. The method of claim 1, wherein the physicochemical characteristic of the item of interest is a physical property of the item of interest.

4. The method of claim 1, wherein the image data or the spectral data comprises a high-resolution point cloud.

5. The method of claim 1, further comprising executing and assembling sinusoidal scan patterns with the gimbal system along the yaw axis and the pitch axis to collect the image data and the spectral data.

6. The method of claim 1, the scanning spectrometer system further comprising a xenon lamp mounted on the gimbal system for night-time broad-spectrum spectroscopy.

7. A method of adaptively scanning a selected area, the method comprising:
selecting an imaging mode from a plurality of imaging modes, wherein the imaging mode determines at least one of a scanning pattern, a scanning speed, and a scanning rate;
performing a scan of the selected area using the imaging mode, wherein performing the scan comprises gathering spectral data and image data;
detecting an item of interest using at least one of the spectral data and the image data;
automatically selecting a new imaging mode from the plurality of imaging modes in response to detecting the item of interest; and
performing a scan of the item of interest using the new imaging mode to gather additional spectral data and additional image data of the item of interest.

8. The method of claim 7, further comprising providing a scanning spectrometer system to perform the scan of the selected area, the scanning spectrometer system comprising:
a gimbal system configured to provide at least two degrees of freedom to the scanning spectrometer system;
a spectrometer mounted on the gimbal system and configured to gather spectral data; and
a camera mounted on the gimbal system and configured to gather image data.

9. The method of claim 8, further comprising executing and assembling sinusoidal scan patterns with the gimbal system to collect the image data and the spectral data.

10. The method of claim 7, further comprising estimating a physicochemical characteristic of the item of interest based on the additional spectral data and the additional image data.

11. The method of claim 10, wherein the physicochemical characteristic of the item of interest is a plant biotic stress or a plant abiotic stress.

12. The method of claim 10, wherein the physicochemical characteristic of the item of interest is a physical property of the item of interest.

13. The method of claim 7, wherein the image data or the spectral data comprises a high-resolution point cloud.

14. A scanning spectrometer system for adaptively scanning a selected area, the scanning spectrometer system comprising:
a gimbal system having a coordinate frame with a yaw axis and a pitch axis, wherein the gimbal system provides a degree of freedom about the yaw axis and a degree of freedom about the pitch axis;
a spectrometer mounted on the gimbal system and configured to gather spectral data;
a camera mounted on the gimbal system and configured to gather image data; and
a processing unit communicatively coupled with the spectrometer and the camera, wherein the processing unit is configured to receive the spectral data and the image data from the spectrometer and the camera, respectively, detect an item of interest using at least one of the spectral data and the image data and estimate a physicochemical characteristic of the item of interest based on at least one of the spectral data and the image data;
wherein the scanning spectrometer system is configured to:
select an imaging mode from a plurality of imaging modes, wherein the imaging mode determines at least one of a scanning pattern, a scanning speed, and a scanning rate;
perform a scan of the selected area using the imaging mode to gather the spectral data and the image data;
automatically select a new imaging mode from the plurality of imaging modes in response to detecting the item of interest; and
perform a scan of the item of interest using the new imaging mode to gather additional spectral data of the item of interest using the spectrometer and additional image data of the item of interest using the camera.

15. The scanning spectrometer system of claim 14, the spectrometer having a collimating lens.

16. The scanning spectrometer system of claim 14, wherein the physicochemical characteristic of the item of interest is a plant biotic stress or a plant abiotic stress.

17. The scanning spectrometer system of claim 14, wherein the physicochemical characteristic of the item of interest is a physical property of the item of interest.

18. The scanning spectrometer system of claim 14, wherein the image data or the spectral data comprises a high-resolution point cloud.

19. The scanning spectrometer system of claim 14, wherein the gimbal system is configured to execute sinusoidal patterns along the yaw axis and the pitch axis of the coordinate frame.

20. The scanning spectrometer system of claim 14, further comprising a xenon lamp mounted on the gimbal system for night-time broad-spectrum spectroscopy.
